(19) United States
(12) Patent Application Publication
(10) Pub. No.: US 2006/0218497 A1
(43) Pub. Date: Sep. 28, 2006

(54) On-demand locale resource loading for pervasive devices

(75) Inventors: Daniel Q. Chen, Chelmsford, MA (US); Bei Shu, Shanghai (CN); Jie Peng Chen, Shanghai (CN)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/091,212

(22) Filed: Mar. 28, 2005

(51) Int. Cl. H04N 5/44

(52) U.S. Cl. 715/716

(57) ABSTRACT

A method, system and apparatus for on-demand locale resource loading for pervasive devices can include a locale resource data server and one or more pervasive devices configured for communicative coupling to the locale resource data server. A remote registry of locale resource data can be disposed in the locale resource data server which remote registry can include a complete set of locale resource data for a multiplicity of locales. Likewise, a local registry of locale resource data can be disposed in each pervasive device, which local registry can store a limited subset of the locale resource data in the remote registry. Importantly, a locale resource management module can be disposed in each pervasive device. The locale resource management module can be programmed to retrieve locale resource data from the remote registry when locale resource data disposed in the local registry cannot support a request to change to a proposed locale.

### BACKGROUND OF THE INVENTION

1. Statement of the Technical Field

The present invention relates to the field of pervasive computing and more particularly to processing local resources in a pervasive environment.

2. Description of the Related Art

Personal computers no longer are the most common vehicle through which users connect to data communications networks like the Internet. Now that computing can be viewed as being truly everywhere, computer scientists and information technologists have begun to rethink those services that can be provided to meet the needs of mobile computing users. In consequence, the study of pervasive computing has resulted in substantial innovation in the field of network connectivity. “Pervasive computing” has been defined as referring to any non-constrained computing device not physically tethered to a data communications network. Thus, pervasive computing devices refer not only to computers wirelessly linked to networks, but also to handheld computing devices, wearable systems, embedded computing systems and the like.

In order to meet the needs of a global market, pervasive applications must be configured to support multiple languages. To accommodate different languages, often the text display of the user interface and formatting conventions for data in the user interface can change from locale to locale. Specifically, to support users communicating in different languages, pervasive applications must not only use translated text, but the user interface of an application must adapt to local conventions. These conventions can differ by language or region and can include the formatting of numbers, dates, times, and currency values, as well as the support for differences in measurement units, text sorting order, and other services.

To support multiple locales, pervasive applications or their host operating systems maintain a repository of locale data to support the different conventions for different locales. Generally, the repository can include all locale resource data for many different locales. As it would be expected, the repository can be quite large and can consume substantial storage space. For the typical desktop computing environment, the size of the repository will be of no consequence. In the pervasive environment, however, the size of the repository can be problematic.

Specifically, the size of the locale data within the repository can range from eight (8) megabytes (MB). Notwithstanding, pervasive device are constrained in respect to storage. For example, a typical handheld computer enjoys maximum fixed storage in the range of sixty-four (64) MB. Yet, the fixed storage for a handheld computer supports not only application data, but the applications themselves. Under such constraints, it is not practical to install the entire 8 MB repository in a handheld computer. Conversely, if only a limited set of locale resource data is installed in the pervasive device, the limited nature of the locale resource data can inhibit the support for locale formatting for applications in the device. For example, when deploying an application to a pervasive device, the application cannot support concurrent international formatting for all locales—especially for Chinese, Korean, and Japanese together with other locales such as German and French.

### SUMMARY OF THE INVENTION

The present invention addresses the deficiencies of the art in respect to locale support in a pervasive device and provides a novel and non-obvious method, system and apparatus for on-demand locale resource loading in a pervasive device. A system for on-demand locale resource loading for pervasive devices can include a locale resource data server and one or more pervasive devices configured for communicative coupling to the locale resource data server. A remote registry of local resource data can be disposed in the locale resource data server which remote registry can include a complete set of locale resource data for a multiplicity of locales. For instance, the multiplicity of locales can include Japanese, Chinese and Korean, as well as other locales such as German and French to name a few.

Likewise, a local registry of locale resource data can be disposed in each pervasive device, which local registry can store a limited subset of the locale resource data in the remote registry. Importantly, a locale resource management module can be disposed in each pervasive device. The locale resource management module can be programmed to retrieve locale resource data from the remote registry when locale resource data disposed in the local registry cannot support a request to change to a proposed locale. Finally, a globalization module can be coupled to application logic and programmed to utilize the limited subset of locale resource data in the local registry to render a user interface for the application logic for a specified locale.

A method for on-demand locale resource loading for pervasive devices can include receiving a request to change to a proposed locale in a pervasive device and searching a local registry for locale resource data specified to support the proposed locale. If the locale resource data cannot be located in the local registry, locale resource data specified to support the proposed locale can be retrieved from a remote registry. In this regard, the remote registry can be configured to store a complete set of locale resource data and the local registry can be configured to store a limited subset of the complete set of locale resource data.

In any case, the locale resource data can be loaded in the pervasive device to support the proposed locale. Notably, the retrieving step can include determining if requested locale resource data to support the proposed locale can be located within the remote registry. If the requested locale resource data can be located in the remote registry, the requested locale resource data can be retrieved from the remote server and stored in the local registry. Otherwise, a next best set of locale resource can be requested from the remote server and stored in the local registry.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a pervasive device disposed in a computer communications network and configured for on-demand locale resource loading in accordance with the present invention; and,

FIG. 2 is a flow chart illustrating a process for on-demand local resource loading for pervasive devices.

### DETAILED DESCRIPTION OF THE PREFERRED EMBODIMENTS

The present invention is a method, system and apparatus for on-demand locale resource loading for pervasive devices. In accordance with the present invention, a limited set of locale resource data can be disposed in a locale resource registry in a pervasive device. Responsive to a request to switch locales, the registry can be searched to determine whether existing locale resource data in the registry can support the newly requested locale. If not, a request can be forwarded over a data communications network to a remote registry to locate and retrieve locale resource data sufficient to support the newly requested locale. In this way, the size of the locale resource registry disposed within the pervasive device can be minimized to accommodate the resource limited nature of the pervasive device.

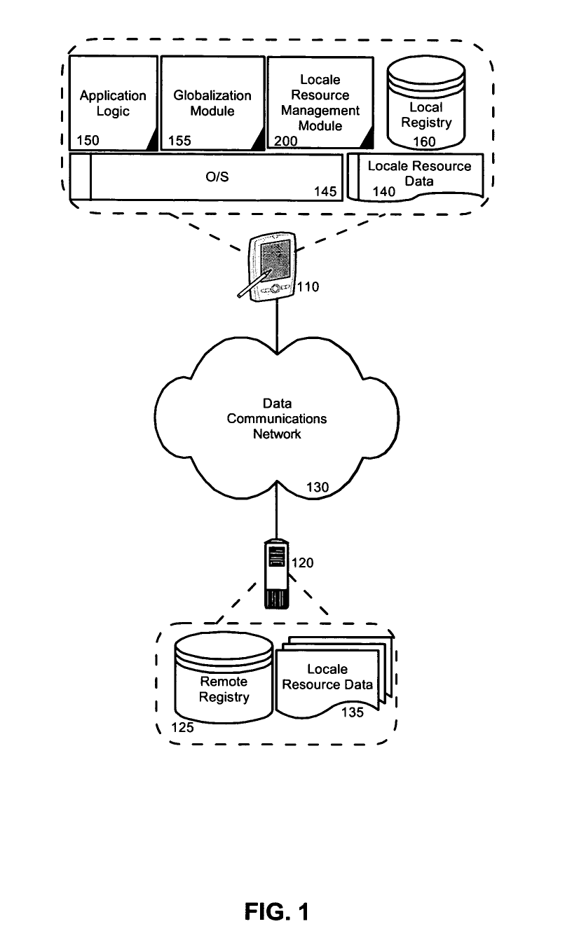

In further illustration, FIG. 1 is a schematic illustration of a pervasive device disposed in a data communications network and configured for on-demand locale resource loading in accordance with the present invention. The system can include a pervasive device 110 configured for communicative coupling to a remote locale resource server 120 over a data communications network 130, for example the global Internet. The remote locale resource server 120 can include a remote registry 125 having a complete set of locale resource data 135 for a multiplicity of locales, irrespective of the size of the remote registry 125.

The pervasive device 110 can include an operating system 145 configured to support the operation of application logic 150. The pervasive device 110 also can include a globalization module 155 programmed to support different locales in the operation of the application logic 150. To that end, the globalization module 155 can utilize locale resource data 140 disposed in a local registry 160 having only a limited set of the locale resource data 135 included in the remote registry 125.

Locale resource management logic 200 can manage the content of the local registry 160. Specifically, in response to a request to change locales in the globalization module 155, the local resource management module 200 can search the local registry to determine whether already included local resource data can support the request. If so, the locale resource data 140 already disposed in the local registry 160 can be loaded for use by the globalization module 155. Otherwise, the locale resource management module 200 can issue a request to the remote locale resource server 120 to retrieve suitable locale resource data 135 from the remote registry 135.

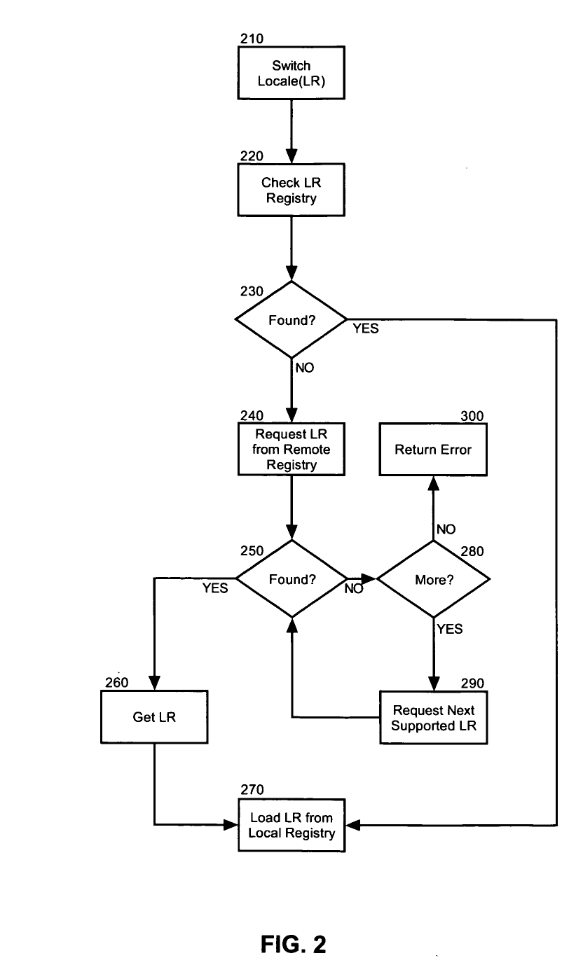

In more particular illustration of the operation of the locale resource management module 200, FIG. 2 is a flow chart illustrating a process for on-demand local resource loading for pervasive devices. Beginning in block 210, a request can be received to switch locales from a current locale to a proposed locale. In block 220, the local registry can be inspected to determine whether locale resource data already disposed within the local registry can be loaded to support the proposed locale. If, in decision block 230, suitable locale resource data can be located in the local registry to support the proposed locale, in block 270 the locale resource data can be loaded from the local registry.

In decision block 230, suitable locale resource data cannot be located in the local registry to support the proposed locale, in block 240 a request can be issued to a remote locale resource server to locate within a remote registry suitable locale resource data to support the proposed locale. In decision block 250, if suitable locale resource data can be located in the remote registry, in block 260 the locale resource data can be retrieved from the remote registry and placed in the local registry. Subsequently, in block 270, the newly retrieved locale resource data can be loaded from the local registry.

In decision block 250, if suitable locale resource data cannot be located in the remote registry, in decision block 280 it can be determined whether additional locale resource data for other locales can be located in the remote registry. If so, in block 290, locale resource data for a next nearest locale can be requested and in block 250, it can be determined whether locale resource data can be retrieved from the remote registry for the next nearest locale. If so, the locale resource data can be retrieved from the remote registry for the next nearest locale in block 260 and subsequently loaded for use in block 270. Otherwise, the process can continue until no additional locale resource data remains to be processed. In that circumstance, in block 300 an error condition can be returned.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A system for on-demand locale resource loading for pervasive devices, the system comprising:
a locale resource data server;
a plurality of pervasive devices configured for communicative coupling to said locale resource data server;
a remote registry of local resource data disposed in said locale resource data server, said remote registry comprising a complete set of locale resource data for a multiplicity of locales;
a local registry of locale resource data disposed in each of said pervasive devices, said local registry storing a limited subset of said locale resource data in said remote registry; and,
a locale resource management module disposed in each of said pervasive devices and programmed to retrieve locale resource data from said remote registry when locale resource data disposed in said local registry cannot support a request to change to a proposed locale.

2. The system of claim 1, wherein said multiplicity of locales comprise Japanese, Chinese and Korean.

3. The system of claim 1, wherein said multiplicity of locales comprise German and French.

4. The system of claim 1, further comprising a globalization module coupled to application logic and programmed to utilize said limited subset of locale resource data in said local registry to render a user interface for said application logic for a specified locale.

5. A method for on-demand locale resource loading for pervasive devices, the method comprising the steps of:
receiving a request to change to a proposed locale in a pervasive device;
searching a local registry for locale resource data specified to support said proposed locale;
retrieving locale resource data specified to support said proposed locale from a remote registry if said locale resource data cannot be located in said local registry; and,
loading said locale resource data in said pervasive device to support said proposed locale.

6. The method of claim 5, wherein said retrieving step comprises the steps of:
determining if requested locale resource data to support said proposed locale can be located within said remote registry;
retrieving said requested locale resource data from said remote server and storing said retrieved locale resource data in said local registry if said requested locale resource data can be located in said remote registry; and,
otherwise requesting a next best set of locale resource from said remote server and storing said next best locale resource data in said local registry.

7. The method of claim 5, further comprising the step of configuring said remote registry to store a complete set of locale resource data and configuring said local registry to store a limited subset of said complete set of locale resource data.

8. A machine readable storage having stored thereon a computer program for on-demand locale resource loading for pervasive devices, the computer program comprising a routine set of instructions which when executed by a machine causes the machine to perform the steps of:
receiving a request to change to a proposed locale in a pervasive device;
searching a local registry for locale resource data specified to support said proposed locale;
retrieving locale resource data specified to support said proposed locale from a remote registry if said locale resource data cannot be located in said local registry; and,
loading said locale resource data in said pervasive device to support said proposed locale.

9. The machine readable storage of claim 8, wherein said retrieving step comprises the steps of:
determining if requested locale resource data to support said proposed locale can be located within said remote registry;
retrieving said requested locale resource data from said remote server and storing said retrieved locale resource data in said local registry if said requested locale resource data can be located in said remote registry; and,
otherwise requesting a next best set of locale resource from said remote server and storing said next best locale resource data in said local registry.

10. The machine readable storage of claim 8, further comprising an additional set of instructions which when executed by the machine causes the machine to further perform the step of configuring said remote registry to store a complete set of locale resource data and configuring said local registry to store a limited subset of said complete set of locale resource data.
